(19) United States
(12) Patent Application Publication
(10) Pub. No.: US 2003/0126007 A1
(43) Pub. Date: Jul. 3, 2003

(54) Network marketing franchise system

(76) Inventors: Bernadino Pavone, Plymouth, MI (US); Gloria Tactac, (US); Abood Samaan, (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/038,588

(22) Filed: Jan. 2, 2002

(51) Int. Cl. G06F 17/60

(52) U.S. Cl. 705/10

(57) ABSTRACT

A method of operating a network marketing company in which a franchise opportunity is offered to persons who would not be entitled to the franchise opportunity in a traditional network marketing environment.

### FIELD OF THE INVENTION

The present invention relates to network marketing systems and, more specifically, to an innovative method of conducting a network marketing business.

### BACKGROUND OF THE INVENTION

Consumers and commercial enterprises buy and sell a vast array of goods and services in the United States each year using network marketing. Based on the proposition that customers are often the best advocates for the products and services they buy, network marketing offers customers of a product the opportunity to sell the products to others and to build networks of others like them.

Firms that sell products and services using network marketing (network marketing company(ies)) typically recruit independent sales representatives. The independent sales representatives then may (but are not required to) recruit others, who then may (but are not required to) recruit still others. For example, using a basic assumption that each of a firm's independent sales representatives recruits three others, and that each of those recruits three others, the firm can have almost a thousand independent sales representatives by the sixth iteration of the process.

Network marketing is a powerful tool that makes use of the personal contacts that almost any potential independent sales representative has simply by virtue of his or her normal social circles. The larger a representative's social circle and the harder the representative is willing to work, the greater the representative's potential to build a successful sales network for the firm.

Network marketing systems are also efficient in that they operate with very little overhead. Each sales representative is an independent operator in a contractual relationship with the firm. Sales representatives usually operate out of their homes and they manage their own inventory and ordering processes. Sales representatives build networks from circles of existing acquaintances and this, although time-intensive, saves the network marketing company the substantial expense of identifying potential sales representatives from among populations of strangers.

So successful has network marketing been in circumventing the traditional brick-and-mortar methods of retail business that network marketing companies are now finding it difficult to use some of the beneficial tools of the traditional retail world they used to eschew.

Some network marketers have integrated more traditional retail operations with person-to-person network-building by allowing representatives who have proven themselves in developing networks to operate from retail storefronts, kiosks, carts or other traditional retail points of sale. That said, every such known prior art organization requires that the representatives who operate traditional retail points of sale first build a sales network from scratch and meet certain minimum requirements as to network depth, breadth, sales volume or some combination of these criteria.

This strategy, though successful, deprives firms of access to a valuable population of potential representatives: those (a) without the personal contacts, time or patience required to develop networks that meet the requirements to open a traditional retail point of sale, but (b) who nevertheless have (i) sales skills and (ii) the necessary capital to invest in such a point of sale.

Traditional retail points of sale are potentially valuable to network marketing companies, but the current business model cannot place those points of sale in the market in less than the time it takes for an independent sales representative to develop a substantial network (if such an independent sales representative is even available in the desired market).

Accordingly, it would be desirable to provide a method by which a network marketing companies can use traditional retail points of sale in a more efficient manner.

### SUMMARY OF THE INVENTION

In one aspect, the present invention provides a method of network marketing including the steps of choosing a product or service to be sold to consumers; forming a business organization such as a corporation or a limited liability company to market the product or services; forming a contractual relationship between the business organization and sales representatives on an independent contractor basis, wherein the sales representatives are compensated for selling the products and/or services of the business organization and for the sales generated by additional sales representatives recruited by the sales representatives for the business organization; creating a plurality of levels of compensation for the sales representatives, wherein compensation increases based, among other things, on the sales of the sales representatives recruited, directly or indirectly; providing at one or more of said compensation levels an entitlement for a sales representative to exercise an option to open a franchise retail outlet of said business organization; allowing persons (prospective franchisee(s)) who are not current sales representatives, and existing sales representatives who have not yet achieved the compensation level required for obtaining a franchise retail outlet, to make an offer to open a franchise retail outlet in a specific geographic area upon payment of a franchising fee; conditioning the acceptance of the offer upon a refusal by all existing sales representatives in the specified geographic area to open the franchise retail outlet for a pre-specified fee; offering the availability of the franchise retail outlet to all existing sales representative in the specified geographic area; and granting the franchise to the prospective franchisee only if all existing sales representatives fail to exercise their option to open the franchise retail outlet.

### BRIEF DESCRIPTION OF THE DRAWINGS

FIG. 1 is a diagram that illustrates a multi-level marketing hierarchy.

FIG. 2 is a diagram that illustrates multiple compensation levels.

FIG. 3 is a flow chart of the method of the present invention.

### DETAILED DESCRIPTION OF THE PREFERRED EMBODIMENTS

In order to provide a better understanding of the present invention, the following terms are defined herein, but such definitions shall not limit the ordinary meaning of these terms:

(a) “downline” means the marketing network of independent sales representative(s) recruited by a given independent sales representative, whether directly (by personally recruiting such independent sales representatives) or indirectly (by having such independent sales representatives recruit still another independent sales representatives, and so on in each iteration).

(b) “network marketing company” means a person who sells goods and/or services through a network. A network marketing company is part of every independent sales representative's upline and every independent sales representative is part of the network marketing company's downline.

(c) “franchise” means a contract or agreement or other relationship, either express or implied, whether oral or written, between two or more persons to which all of the following apply: (i) a franchisee is granted the right to engage in the business of offering, selling, or distributing goods or services under a marketing plan or system prescribed in substantial part by a franchisor, (ii) a franchisee is granted the right to engage in the business of offering, selling, or distributing goods or services substantially associated with the franchisor's trademark, service mark, trade name, logotype, advertising, or other commercial symbol designating the franchisor or its affiliate, and (iii) the franchisee is required to pay, directly or indirectly, a fee for the rights described in clauses (i) or (ii) above.

(d) “franchisee” means a person who (i) is granted by another the right to engage in the business of offering, selling, or distributing goods or services under a marketing plan or system prescribed in substantial part by that other, who (ii) receives from another the right to engage in the business of offering, selling, or distributing goods or services substantially associated with that other's trademark, service mark, trade name, logotype, advertising, or other commercial symbol designating the other or its affiliate, and who (iii) pays a fee to another for the rights described in clauses (i) or (ii) above.

(e) “franchisor” means a person who (i) grants to another the right to engage in the business of offering, selling, or distributing goods or services under a marketing plan or system prescribed in substantial part by that person, who (ii) grants to another the right to engage in the business of offering, selling, or distributing goods or services substantially associated with that person's trademark, service mark, trade name, logotype, advertising, or other commercial symbol designating that person or its affiliate, and who (iii) receives a fee from another for the rights described in clauses (i) or (ii) above.

(f) “independent sales representative” means a person who sells the products of a network marketing company in a network marketing system in return for compensation. An independent sales representative may, but need not, recruit other persons to be independent sales representatives in the same network. Independent sales representatives are typically independent contractors under state laws.

(g) “network” and “network marketing system” mean a system under which a network marketing company and independent sales representative(s) enter into, and perform under, one or more independent contractor agreements under which independent sales representatives may sell goods and/or services for the networking marketing company to customers and receive compensation for the network marketing company or another person in the independent sales representative's upline; and the independent sales representatives may recruit other persons to be independent sales representative and be compensated based on the sales of the goods and/or services by other independent sales representatives in the independent sales representative's downline.

(i) “person” means an individual, corporation, partnership, limited partnership, limited liability company, association, joint-stock company, trust, an unincorporated organization or other organization.

(j) “retail outlet” means any retail point of sale bearing, or associated with, signage or other indicia disclosing the operator of the point of sale or the products or services sold there and that: (a) is in a fixed location or (b) is associated with a substantial but movable object, which object is usually stationary or is located in one or more particular places for 25% or more of the time it is used for retail sales. For example (and without limitation), a storefront, mall store, stand-alone building, kiosk or cart, would each be a retail outlet. As a further example, neither a motor vehicle nor a recreational vehicle, if either failed to meet the criteria of clause (b) above, would be a retail outlet.

(k) “upline” means the network of independent sales representatives through which a given independent sales representative was recruited.

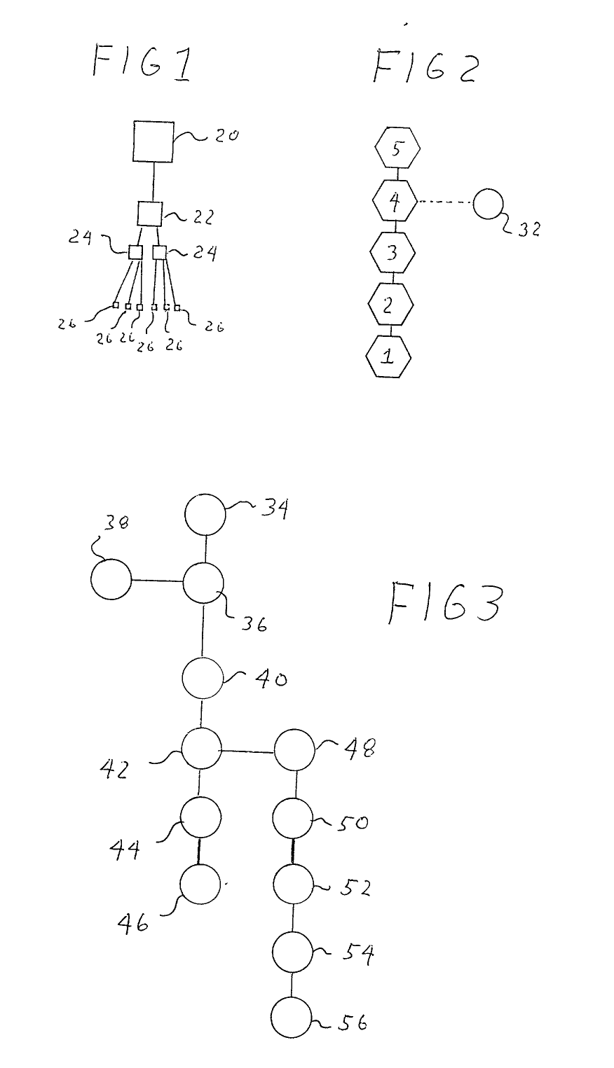

Referring now to FIG. 1 of the drawings, network marketing company 20 is shown. Although network marketing company 20 can be an unincorporated individual, it is preferably a juristic entity such as a corporation or limited liability company. Network marketing company 20 enters into a contractual relationship on an independent contractor (non-employee) basis with independent sales representative 22. This contractual relationship includes provisions providing for payment by the network marketing company of compensation to independent sales representative 22 for each sale of goods or services by independent sales representative 22. The contractual relationship between network marketing company 20 and independent sales representative 22 further provides that independent sales representative 22 will be compensated based on sales by additional recruited independent sales representatives 24 and their downline counterparts 26.

The contractual relationship between independent sales representative 22 and network marketing company 20 further provides that based on reaching a preselected sales quota and/or predefined aspects of network downline, independent sales representative 22 moves upward in network marketing organization 28. As shown in FIG. 2 of the drawings, each level (tiers 1-5) provides greater compensation and privileges to independent sales representative 22. In this embodiment, at tier 4, independent sales representative 22 is eligible to open a retail outlet 30, most preferably a traditional “brick and mortar” retail store. In addition to reaching tier 4, additional conditions may be imposed on independent sales representative 22 for exercising the option to open retail outlet 30.

Referring still to FIG. 2 of the drawings, franchisee 32 is shown. Franchisee 32 may be a non-incorporated individual or a juristic entity (e.g., corporation) who is not a current independent sales representative of network marketing company 20. Alternatively, franchisee 32 may be an existing independent sales representative who has not yet reached the retail outlet option tier of network marketing organization 28.

Referring now to FIG. 3 of the drawings, the innovative business method of the present invention will be described. In step 34, a prospective franchisee is identified. The prospective franchisee is not a current independent sales representative of network marketing company 20; that is, the person or juristic entity wishes to become an independent sales representative for network marketing company 20 by opening a retail outlet, for the sale of goods and/or services of network marketing company 20 and for recruiting additional downstream independent sales representatives for network marketing company 20.

In step 36, the prospective franchisee is evaluated by network marketing company 20 (franchisor) to determine whether it possesses the qualifications necessary for becoming a franchisee. These qualifications preferably include the ability to purchase the franchise for a predetermined sum; a predetermined credit rating; and some sales experience. Other qualifications may also be imposed. In the event that the prospective franchisee does not possess the necessary qualifications, then the process ends at step 38 and the application by the prospective franchisee is denied.

In the event that the prospective franchisee is qualified, a franchise agreement is negotiated with the prospective franchisee in step 40, which is conditioned upon a refusal to exercise a franchise option by an existing independent sales representative, as will be described more fully hereinafter. In step 42, network marketing company 20, having reached a conditional franchise agreement with the prospective franchisee issues a query for any existing independent sales representative of network marketing company 20 who has a right of first refusal for the franchise opportunity. The query for an existing independent sales representative is limited to those independent sales representatives who are within a preselected geographic area surrounding the general site (preferably a radius of from 10-100 miles from the proposed site) of the proposed franchise as defined in the conditional franchise agreement. In one preferred embodiment, the query is further limited to that existing independent sales representative who is at the highest level of compensation as determined in FIG. 2 of the drawings.

In the event that either no qualifying existing independent sales representative exists or, in the event that no qualified existing independent sales representative wishes to exercise the right to open the franchise, then in step 44 the franchise transaction with the prospective franchisee becomes non-conditional and the franchise transaction is completed. In step 46, the franchisee performs under the franchise agreement. The franchise agreement typically includes not only the right to operate a retail outlet on a franchise basis for network marketing company 20, it preferably affords the franchisee all of the benefits afforded independent sales representatives at the franchise entitlement level (tier 4) of the company. That is, if at step 48 a qualified independent sales representative does not wish to exercise the option of first refusal, then the prospective franchisee obtains the franchise.

Referring again to step 48, if a qualified independent sales representative exercises the option to open the franchise (exercises the right of first refusal), in step 50, the prospective franchisee is notified that the franchise is not available. At step 52, the qualified independent sales representative receives the franchise, wherein the franchise agreement is signed at step 44 and the franchise is operated at step 56 by the independent sales representative.

What is claimed is:

1. A method of operating a multi-level network marketing company with independent sales representatives comprising the steps of:
providing a multi-level network marketing company;
providing a tiered compensation level system for payment of said independent sales representatives, movement between said tiers being a function of productivity of said independent sales representative;
providing at one or more of said tiers an entitlement for said independent sales representatives to open a retail outlet of said network marketing company;
offering to persons who do not have an entitlement to open said retail outlet an option to open said retail outlet under a franchise arrangement, said option being conditioned upon a refusal by any qualified existing independent sales representative to open said franchise retail outlet; and
offering said opportunity to open a franchise retail outlet to said qualified existing independent sales representatives.

2. The method of operating a network marketing company recited in claim 1, wherein said network marketing company sells services.

3. The method of operating a network marketing company recited in claim 1, wherein the network marketing company sells goods.

4. The method of operating a network marketing company recited in claim 1, wherein said productivity is an increase in sales by said independent sales representatives.

5. The method of operating a network marketing company recited in claim 1, wherein said productivity is measured by the sales or other qualifications or activities of additional independent sales representatives said independent sales representative recruited into the network marketing company's network.

6. The method of operating a network marketing company recited in claim 1, wherein said independent sales representatives are independent contractors.

7. The method of operating a network marketing company recited in claim 1, wherein said persons who do not have an entitlement to open said franchise retail outlet are entities that are not current independent sales representatives of said network marketing company.

8. The method of operating a network marketing company recited in claim 1, wherein said persons who do not have an entitlement to open said retail outlet are existing independent sales representatives of said network marketing company who have not yet reached said entitled tier of compensation.

9. The method of operating a network marketing company recited in claim 1, wherein said option is geographically limited.

10. The method of operating a network marketing company recited in claim 1, further comprising the step of granting said retail outlet franchise to said qualified existing independent sales representative.

11. The method of operating a network marketing company recited in claim 1, further comprising the step of granting said retail outlet franchise to said persons who do are not otherwise entitled to open said retail outlet under said tiered compensation level system.

12. The method of operating a network marketing company recited in claim 1, wherein the goods and/or services sold are motor vehicles or parts or services related to motor vehicles.
